(19) United States
(12) Patent Application Publication
(10) Pub. No.: US 2006/0259393 A1
(43) Pub. Date: Nov. 16, 2006

(54) Method of using an automatic trading machine as a medium trading relay and apparatus thereof

(76) Inventor: Chang-Jen Chen, Taipei City (TW)

Correspondence Address: G. LINK CO. LTD., 3550 Bell Road, Minooka, IL, 60447, US

(21) Appl. No.: 11/125,356

(22) Filed: May 10, 2005

(51) Int. Cl. G06Q 40/00

(52) U.S. Cl. 705/37

(57) ABSTRACT

A method of using an automatic trading machine as a medium trading relay is characterized in that the automatic trading machine, which has a merchandise in and out control system, a pricing and accounting system and storage spaces, is acted as a trading platform and being disposed at a fixed location, which is commonly confirmed by a seller, a buyer and supplier. The merchandise is stored into a system of the automatic trading machine directly by the seller and the buyer is confirmed and completes payment at the automatic trading machine based on notification of the automatic trading machine or the seller to solve hard problem concerning economy and security met during both sides or multiple sides dealing with merchandise trading and payment trading in the process of medium trading.

### FIELD OF THE INVENTION

The present invention relates to a method of medium trading such as internet shopping, mail order and television shopping and, particularly, to a method of using an automatic trading machine as a medium trading relay and an apparatus thereof for improving the ways of payment done by the buyer and merchandise given done by the seller.

### BACKGROUND OF THE INVENTION

Although the medium trading has been used for years, payment and merchandise-given are always problems doubted by some people due to the medium trading being a kind of trading without face to face. It is doubted if the way of payment is secure and if the merchandise is safely delivered to the buyer. Most people still believe that it is the safest way to receive the ordered merchandise at the time of payment being done. Thus, in order to be satisfied by the seller and the buyer, the medium trading extends to a kind of delivery service with the payment being done at the time of the merchandise having been delivered to the buyer or a kind of convenience store trading type with which the payment and the merchandise-given are conducted in the convenience chain store. However, it results in extra cost is created in addition to the original cost of the medium trading, which shortens distance between the producer and the consumer and lower the trading cost.

The greatest advantages of the payment being done at the time of the merchandise having been delivered to the buyer are providing convenience for the buyer and safety for both the seller and the buyer. But, the greatest advantages cost delivery labor hours and transportation tool expense and the extra costs probably are higher than the price of the merchandise itself. This is not original design of the medium trading in spite of the extra costs being taken care by the seller or the buyer.

Another deficiency of the payment being done at the time of the merchandise having been delivered to the buyer is that personal privacy and time of delivery are often affected by that it is not possible for the deliver person and buyer to estimate exact time of delivery so that a lot of waiting time and redelivery time are spent. Even more, another trading loss occurs due to trading being not completed caused by a delivery problem.

The payment and the merchandise-given being conducted in a convenience chain store has its advantage because no additional delivery truck needed for sending the ordered merchandise and the buyer is able to decide time of picking up the ordered merchandise and not necessary to worry about if the merchandise is able to be picked up after payment. However, all the ordered merchandises have to be sent to the delivery warehouse by the supplier in advance and then each of the merchandise is distributed to the assigned convenience store based on the instruction on the respective merchandise. Next, the medium sends a brief message or email to the buyer to remind the buyer paying and picking up the merchandise. To analyze in detail, there are still a lot of processes, procedures and costs needed to count.

Further, it is getting more medium trading relying on the internet and all the merchandise deposited in the convenience chain stores are often unclearly checked during the clerks changing shift to result in incomplete trading and becoming troubles of all sides. In addition, profit sharing with all stages of the trading process degrades superiority of the medium trading. More seriously, all the financial flows and the goods flows having to transit stage by stage make the processing time being extended except inconvenience.

### SUMMARY OF THE INVENTION

In order to overcome payment and pick-up problems bothering the medium providers, the crux of the present invention is to provide a method of using an automatic trading machine as a medium trading relay and a device thereof, which is characterized in that the automatic trading machine, which has a merchandise in and out control system, a pricing and accounting system and storage spaces, is acted as a trading platform and being disposed at a fixed location, which is commonly confirmed by a seller, a buyer and supplier. The merchandise is stored into a system of the automatic trading machine directly by the seller and the buyer is confirmed and completes payment at the automatic trading machine based on notification of the automatic trading machine or the seller to solve hard problem concerning economy and security met during both sides or multiple sides dealing with merchandise trading and payment trading in the process of medium trading.

An object of the present invention is in that a trading relay or transit station relied by both sides (the seller and the buyer) or more sides (the seller, the buyer, the manufacture and the medium provider) is commonly confirmed and a method using the relay or transit station to perform automatically control of payment collection and merchandise delivery so as to lower uncertainty of human behavior to the least.

Another object of the present invention is in that time of both sides and distance between both sides is capable of being shortened. The seller can deliver the merchandise to an automatic trading machine assigned by the buyer with the least time, the shortest route and the least manpower. The buyer can choose the most suitable automatic trading machine as the location of picking up the ordered merchandise so as not to affect daily work and life for overcoming the uncertainty of time and space bothering all sides.

A further object of the present invention is in that costs including transportation cost, time cost, labor cost and consumption cost resulted from failure trading can be lowered to overcome the deficiency of the prior art such as the deliver person sending the merchandise when the buyer is available and the convenience chain store increasing service cost and trading mistake loss.

A further object of the present invention is in that an unmanned trading environment is created to replace part of the substantive trading market, which occupies very large space and to provide a personal merchandise cabinet for the consumer. The cabinet is designed based on individual need and changeable when it is necessary. When orders are listed, the automatic trading machine becomes a personal shopping cart.

Therefore, the main feature of the present invention is unmanned goods flow system. Once the merchandise is deposited to the storage space of the automatic trading machine, the embedding internet sends information to the buyer and the seller or the goods flow control center automatically. When the subscriber pays and picks up the merchandise, the automatic trading machine sends out message of complete trading to notify the medium provider and all deliver operations of merchandise is processed via the automatic trading system.

Another feature of the present invention is the entire trading process is controlled by open management skill such as information transmission and the medium provider or the supplier can catch all the whole trading message via the digital information offered by the automatic trading machine.

A further feature of the present invention is that each merchandise in the automatic trading machine has been ordered by a specific buyer and this is the greatest difference from the conventional vending machine or electronic shop. The turnover rate of the merchandise in the automatic trading machine is highest and the stuck inventory is hardly exists.

### BRIEF DESCRIPTION OF THE DRAWINGS

The above objects and advantages of the present invention will become more apparent with reference to the appended drawings wherein:

FIG. 1 is a plan view of an automatic trading machine according to the present invention;

FIG. 2 is a plan view illustrating another type of the pick-up gate according to the present invention, which is a central pick-up gate; and

FIG. 3 is a flow chart of a method of using an automatic trading machine as a medium trading relay.

### DETAILED DESCRIPTION OF THE INVENTION

A method of using an automatic trading machine as a medium trading relay and an apparatus thereof according to the present invention can be embodied in the following fields:

(A) The automatic trading machine is belonged to a medium trading provider. The medium trading provider is a seller, a supplier, an automatic trading machine provider and an administrator simultaneously.

(B) The automatic trading machine is an open and common trading window and the user is capable of entering regulation of right and obligation of the system provider via a specific trading system to use systems such as an order system, a delivery and refund system, a payment and pick-up system, an information transmission system and storage system.

(1) The order system: A feature of the order system is in that both sides of medium trading agree an automatic trading machine at a fixed position being the only window for paying and pick-up merchandise and being willing to obey rules of the automatic trading machine. The seller promises to deliver the merchandise to the designated automatic trading machine before an agreed deliver date. The buyer promises to pay and pick up the merchandise at the designated automatic trading machine and the agreed pick-up time once the automatic trading machine or the medium provider sends out a notice of merchandise having arrived. The medium provider offers bar codes or passwords as tools of confirmation while both sides are in the process of trading or the buyer assigns a password as a confirmation of trading.

(2) The delivery and refund system: While receiving an order from the buyer through the medium, the seller notifies the supplier or warehouse to pack the ordered merchandise according to instructions based on trading type agreed with both sides and guides the merchandise into an economical conveying process and delivers to the assigned automatic trading system by means of the most economical mode. The merchandise is deposited into a storage control system in the automatic trading machine with assigned password or bar codes. A refund procedure cannot be processed unless the material handling personnel receives the specific password through the payment and pick-up system or the trading being deleted by either the seller or the buyer.

(3) The information transmission system: A feature of the information transmission system is in that all the information of the automatic trading machine including information related to merchandise coming in and going out, pricing and accounting and storage control can transmit instantly to the medium provider or an information center via digitalized transmission process and the medium provider or the information center decides information distribution routes. Hence, the medium provider acquires information of merchandise having been received right at the time of the merchandise reaching the automatic trading machine. The medium provider can send the information of the buyer having paid and picked up the merchandise to the information control system such that completion time of each trading, special feature of each trading and distribution of time for paying and picking up merchandise can be counted and analyzed. The information transmission system has an input and an output device to transmit various data.

(4) The payment and pick-up system: The payment and pick-up system is similar to various automatic vending machines. The greatest difference of the payment and pick-up system is in that only a specific person is admit to key in a specific password or bar codes and start the pricing and accounting system for completing operation of payment and pick up the merchandise. Once being notified to pick up the merchandise, the buyer has to key in the trading password or the bar codes confirmed by both the seller and the buyer at the assigned automatic trading machine before the pricing and accounting system can be entered. Only after the payment being completed, the storage control system is capable of opening pick-up gate and releasing the merchandise corresponding to the payment to finish the entire trading according to the password, the bar codes and the information of payment.

(5) The storage control system: The storage control system is congregation of a plurality of fixed or movably partitioned storage spaces. Each space has a specific address code with a password or bar code. Once the space is occupied by a specific item of merchandise, which bears an identification code, a new pick-up password is formed and the new pick-up password is composed of the address code and the identification code.

As the forgoing, the automatic trading system is a digitalized trading device combining the storage control system, the pricing and accounting system, the payment and pick-up system and the information transmission system. The automatic trading machine makes trading being unmanned through information control and transmission and shortens distance and time of trading between men such that it is capable of lowering marketing cost and gives both sides of the trading more freedom to process the trading. This is the most outstanding feature of the present invention. The principal technique of the present invention is derived from application of embedding internet and any messages occur in the automatic trading machine or any messages created by the medium trading system can be sent out via the embedding Internet easily and rapidly. Under this circumstance, messages of the automatic trading machine are able to be controlled by a control center at the far end.

Each stage in the method of the present invention has to be certified with preset password or bar code for message transmission so as to constitute a net. A check system is provided in the automatic trading machine for a prepayment card, a credit card, fund transfer with a mobile phone or cash being able to be accessed by the pricing and accounting system safely. The only thing has to be done by the seller at the far end control center is sending an email for renewing trading information of each automatic trading machine according to the address or password of each storage space by way of embedding internet communication. The automatic trading machine can notify and even describe the operation in detail related to merchandise delivery or payment operation of the buyer too.

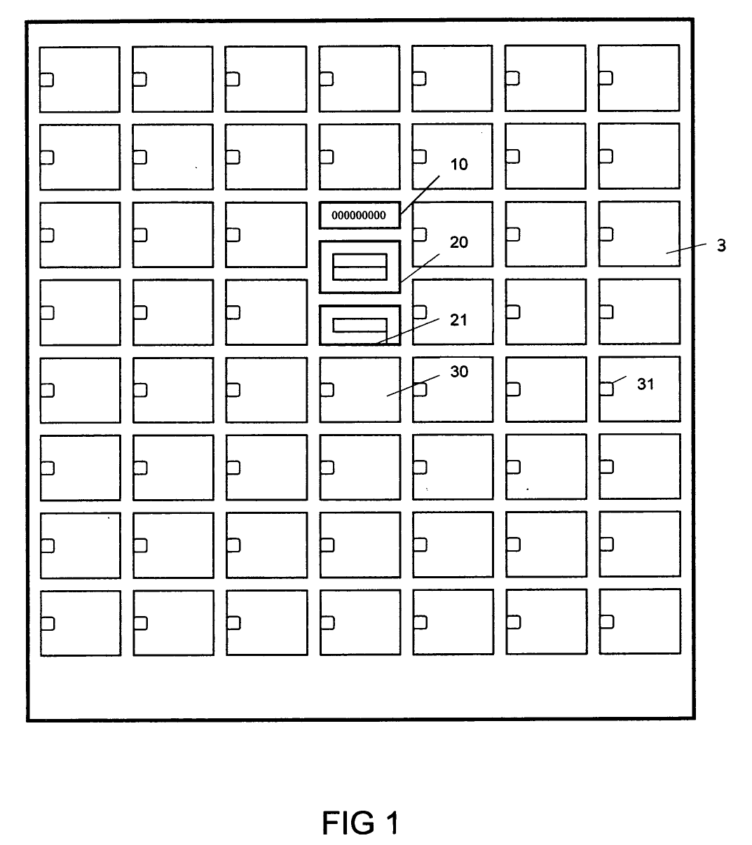

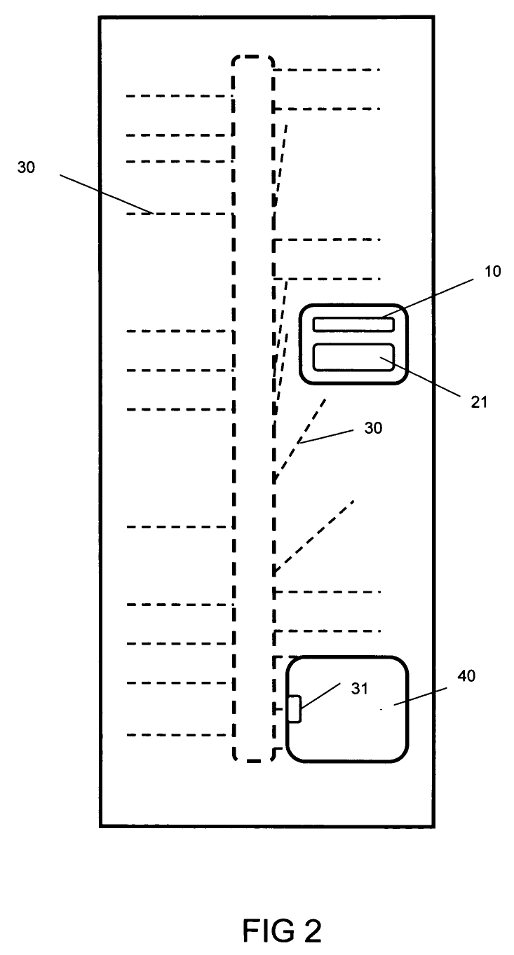

The automatic trading machine can be provided with different designs and arrangements based on sizes of the sold items of the merchandise. Each storage space provided can be different from each other according to different articles so that the storage space can be a shape of track like in a vending machine, a shape of fixed partitioned space such as locker or a mail box as shown in FIG. 1, a shape like a parking tower and each section of merchandise being moved with a conveyer as shown in FIG. 2 or a shape of suspension for hanging articles. The way of placing the merchandise is that each item of the merchandise has a specific number, password or bar code, an address code, messages of coming-in time or going-out time and operation personnel and message of accounting. The information can be embedded into a built-in micro controller or transmitted on the Internet with software.

The method is capable of sending an email automatically to notify the buyer, the supplier, the medium provider, the storage control system and the accounting system immediately right after the merchandise being delivered to the automatic trading machine. In this way, the entire trading process is able to be under control of an automatic system.

As the foregoing, being belonged to an unmanned trading system, the automatic trading machine can be disposed in a corner of a public place like a vending machine, at a corridor outside a house, on an outer wall like a shopping window, in a room or a building like an unmanned automatic bank.

A further special feature of the present invention is refund arrangement. When the merchandise has stayed in the storage space over a preset expired date, the automatic trading machine is capable of notify the seller to note the trading for further treatment such as taking account of buyer's bad trading record, returning the merchandise to the delivery center or the supplier or notifying the original delivery unit taking back the merchandise in addition to sending a message to remind the buyer picking up the merchandise.

FIGS. 1 and 2 illustrate two kinds of automatic trading machines disclosed in the present invention.

Referring to FIG. 1, the automatic trading machine is similar to a set of lockers and each of the storage spaces thereof has a signal light and an output management system. Once the buyer has paid the agreed amount, the signal light flashes to automatically inform where the ordered article is located at and the gate open automatically for the buyer picking up the merchandise. It is noted that the automatic trading machine has a window screen 10, an input device 20, a pricing and accounting system 21, a storage control system 30 and a signal device with in and out control system 31.

FIG. 2 illustrates the automatic trading machine is similar to a vending machine and has a central pick-up opening. This type of system can feed back information and control all matters occurring with the unmanned automatic trading machine from the far end so as to complete collecting payment and hand out the merchandise. It is noted that the automatic trading machine shown in FIG. 2 has a window screen 10, an input device 20, a pricing and accounting system 21, a storage space control system 30, a signal device with in and out control system 31 and a delivery window 40.

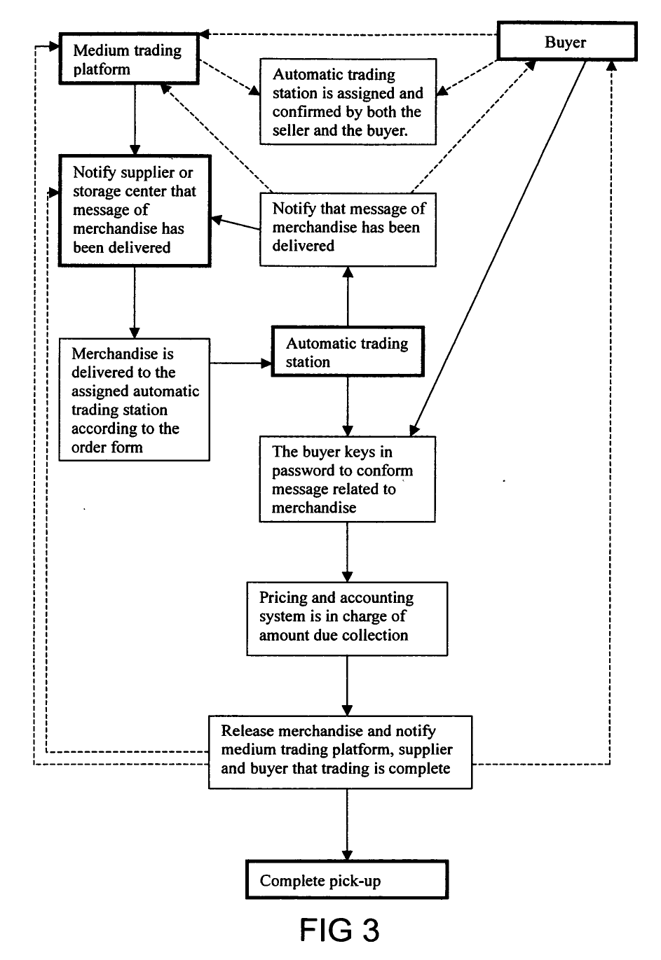

Referring to FIG. 3, a flow chart of the method according to the present invention. It can be seen that the automatic trading machine is a bridge for exchanging the payment and the merchandise between all sides involving the trading. Hence, the entire trading offered by the present invention provides the users more freedom and integrity.

It is appreciated that the method of the present invention allows the merchandise changeable all the time and each item of the merchandise has already had a specific pick-up person so that it is not possible for the present invention to occur idle merchandise to overcome deficiency of the vending machine offering several or several ten items of merchandise only and the merchandise often waiting for purchase instruction for a long period of time.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of using an automatic trading machine as a medium trading relay, comprising the following steps:
(1) the automatic trading machine, which has an in and out control system, a pricing and accounting system and at least a storage space, being acted as a trading platform and being disposed at a fixed location, which is commonly confirmed by a seller, a buyer and supplier;
(2) the seller giving a first set of digital codes to an ordered merchandise and a merchandise bearing the first set of digital codes is admitted to enter a storage system in the automatic trading machine assigned by the buyer after the first set of digital codes and a second set of digital codes, which is for identifying a delivery person, is keyed in;
(3) the automatic trading machine automatically issuing a third set of digital codes, which is used for notifying the seller and the buyer messages concerning the ordered merchandise having entered the storage system and the address of the ordered merchandise in the storage system, to the seller and the buyer;
(4) the buyer inputting the first set of digital codes and the third set of digital codes to acquire a payment certification; and
(5) a storage gate opening automatically and the buyer picking up the ordered merchandise to complete entire trading after procedure of payment being done.

2. The method according to claim 1, wherein the buyer receives a fourth set of digital codes from the seller in case of prepaying the ordered merchandise and the ordered merchandise is picked up once the fourth set of digital codes is keyed in with the automatic trading machine.

3. The method according to claim 1, wherein the digital codes offered by the seller and/or the supplier are bar codes or specific characters including words, digits and symbols.

4. The method according to claim 1, wherein the messages sent from the automatic trading machine via brief message of mobile phone or email.

5. The method according to claim 1, wherein the automatic trading machine is disposed at any open ground by a road or an outer wall of a house facilitating eligible users as a unmanned trading relay.

6. An automatic trading machine, comprising:
a merchandise in and out control devices, having a plurality of specific addresses and admitting a merchandise bearing with digital codes or bar codes;
a storage space, providing a communication device with automatic signal sending function;
a digital code or bar code input and output device; and
an accounting device, providing functions of pricing, paying and fund transfer.

7. The automatic trading machine according to claim 6, wherein the storage space provides a shape such as plurality of independent partitioned spaces like lockers, a plurality of conveyer type movable partitioned spaces, a plurality of detachable partition type flexible spaces, a plurality of track type spaces, a plurality of suspension type spaces or a plurality of fixed spaces and each of the spaces has specific address digital codes or bar codes; a first set of digital codes assigned to an ordered merchandise, a second set of digital codes assigned to a delivering person and a third set of digital codes automatically issued by the automatic trading machine associated with the storage space to control and send information related to the ordered merchandise moving in and out.

8. The automatic trading machine according to claim 6, wherein the merchandise in and out control device performs dynamic record and management by means of various digital code combination being keyed in by different persons at different locations and with different ordered merchandise and timings.

9. The automatic trading machine according to claim 6, wherein the communication device has an embedded internet system or an automatic feedback system to notify a system administrator or a designated information receiver any internal or system changes such as merchandise in, merchandise out, storage time expired and complete trading such that the entire trading process is under control.

10. The automatic trading machine according to claim 6, wherein operation thereof is each stage in the device has to be certified with preset password or a set of bar codes for message transmission so as to constitute a net; a check system is provided therein for a prepayment card, a credit card, fund transfer with a mobile phone or cash being able to be accessed by the pricing and accounting system safely; the only thing has to be done by the seller at a far end control center is sending an email for renewing trading information thereof according to the address or password of each storage space by way of embedding internet communication; the automatic trading machine also can notify and even describe the operation in detail related to merchandise delivery or payment operation of the buyer.

11. The automatic trading machine according to claim 1, wherein when the merchandise has stayed in the storage space over a preset expired date, the seller is notified to care the trading for further treatment such as taking account of buyer's bad trading record, returning the merchandise to the delivery center or the supplier or notifying an original delivery unit taking back the merchandise in addition to sending a message to remind the buyer picking up the merchandise.
